(19) United States
(12) Patent Application Publication
(10) Pub. No.: US 2013/0253161 A1
(43) Pub. Date: Sep. 26, 2013

(54) Methods Of Modifying Metal-Oxide Nanoparticles

(71) Applicants: Masaaki Amako, Ichihara-shi (JP); Maki Itoh, Tokyo (JP); Michitaka Suto, Kanagawa (JP)

(72) Inventors: Masaaki Amako, Ichihara-shi (JP); Maki Itoh, Tokyo (JP); Michitaka Suto, Kanagawa (JP)

(21) Appl. No.: 13/991,851

(22) PCT Filed: Dec. 6, 2011
(86) PCT No.: PCT/US11/63549

§ 371 Date: Jun. 5, 2013

Related U.S. Application Data
(60) Provisional application No. 61/420,925, filed on Dec. 8, 2010.

(51) Int. Cl. C09C 1/36; C09C 1/00

(52) U.S. Cl. CPC C09C 1/3676; C09C 1/00
USPC 528/32

(57) ABSTRACT

Methods employing acidic and basic catalysts are disclosed, and generally entail hydrolysis and condensation reactions of silicon based components. The methods are useful for forming siloxane-modified metal-oxide nanoparticles, such as modified ZrO₂ nanoparticles. The siloxane-modified metal-oxide nanoparticles, and products including the siloxane-modified metal-oxide nanoparticles, can be used to form various products, such as lenses or encapsulants for making various devices, such as, but not limited to, light emitting diodes (LEDs).

### CROSS REFERENCE TO RELATED APPLICATIONS

This application claims the benefit of U.S. Provisional Patent Application Ser. No. 61/420,925 filed on Dec. 8, 2010, which is incorporated herein by reference in its entirety.

### FIELD OF THE INVENTION

The present invention generally relates to methods of modifying metal-oxide nanoparticles and, more specifically, to reaction methods for surface treatment of metal-oxide nanoparticles.

### DESCRIPTION OF THE RELATED ART

Light emitting diodes (LEDs) are well known in the art, and generally comprise one or more diodes (that emit light when activated) that are encapsulated, i.e., encased, in an encapsulant. LED designs utilizing either flip chip or wire bonded chips are connected to the diode to provide power to the diode. When bonding wires are present, a portion of the bonding wires is at least partially encapsulated along with the diode. When LEDs are activated and emitting light, a rapid rise in temperature occurs, subjecting the encapsulant to thermal shock. Accordingly, when the LED is turned on and off repeatedly, the encapsulant is exposed to temperature cycles. In addition to normal use, LEDs are also exposed to environmental changes in temperature and humidity, as well as subject to physical shocks. Therefore, encapsulation is required for optimal performance.

Since siloxane compositions employing silicone resins and copolymers exhibit comparatively superior heat resistance, moisture resistance and retention of transparency relative to epoxy resins, in recent years, LEDs that use siloxane compositions to form encapsulants, primarily blue LEDs and white LEDs, have become more prevalent. Previously disclosed siloxane compositions generally include metal-oxide particles, such as TiO₂, to adjust a refractive index (RI) of the siloxane composition and, specifically, to raise the refractive index of the siloxane composition after curing, e.g. to raise the refractive index of the encapsulant. Unfortunately, many of the aforementioned encapsulants employing conventional metal-oxide particles have refractive indices and optical transparencies which make them undesirable for use in LEDs.

Accordingly, there remains an opportunity to provide improved metal-oxide particles and methods of making the improved metal-oxide particles relative to the prior art. There also remains an opportunity to provide improved siloxane compositions and products, e.g. encapsulants, relative to the prior art.

### SUMMARY OF THE INVENTION AND ADVANTAGES

The subject invention provides methods of forming siloxane-modified metal-oxide nanoparticles. In one inventive method, the method comprises the steps of: I) providing (a) an alkoxysilane having at least one aryl group per molecule, (b) an organosiloxane having at least at least two alkenyl groups per molecule, (c) an acidic catalyst, (d) water, (e) a basic catalyst, (f) metal-oxide nanoparticles, and optionally, (g) a silane having at least one alkenyl group per molecule; II) reacting the alkoxysilane (a) and the organosiloxane (b), in the presence of the acidic catalyst (c), the water (d), and optionally, the metal-oxide nanoparticles (f), to form an intermediate composition including monomers having hydroxyl groups; III) reacting the monomers in the presence of the basic catalyst (e), and optionally, the metal-oxide nanoparticles (f), to form a silsesquioxane resin having residual hydroxyl groups; and optionally, IV) reacting the silsesquioxane resin with the silane (g) to form the siloxane-modified metal-oxide nanoparticles having residual alkenyl groups; wherein the metal-oxide nanoparticles (f) are present during at least one of steps II) and III).

In another inventive method, the method comprises the steps of I) providing (a) an acidic catalyst, (b) metal-oxide nanoparticles, (c) water, (d) an alcohol, (e) a solvent different than the water (c) and alcohol (d), and (f) an alkoxysilane having at least one acryl group per molecule; II) combining the acidic catalyst (a), the metal-oxide nanoparticles (b), and the water (c) to form a first precursor composition; III) combining the alcohol (d), the solvent (e), and the alkoxysilane (f) to form a second precursor composition; and IV) reacting the first and second precursor compositions to form the siloxane-modified metal-oxide nanoparticles.

In another inventive method, the method comprises the steps of: I) providing (a) a sol comprising i) metal-oxide nanoparticles, ii) an acidic component, and iii) water, (b) an alcohol, (c) an alkoxysilane, and (d) a basic catalyst; II) removing at least a portion of the water iii) from the sol (a) to obtain a particle composition; III) mixing the alcohol (b) and the particle composition to form a transitional composition; and IV) reacting the alkoxysilane (c) and the transitional composition to form monomers having hydroxyl groups; and V) reacting the monomers in the presence of the basic catalyst (d) to form the siloxane-modified metal-oxide nanoparticles.

In another inventive method, the method comprises the steps of: I) providing (a) linear- and/or cyclic-siloxane oligomers having residual hydroxyl groups, (b) metal-oxide nanoparticles, and (c) a basic catalyst; and II) reacting the oligomers (a) in the presence of the metal-oxide nanoparticles (b) and the basic catalyst (c) to form the siloxane-modified metal-oxide nanoparticles.

The present invention also provides the siloxane-modified metal-oxide nanoparticles, and siloxane compositions including the siloxane-modified metal-oxide nanoparticles. The siloxane-modified metal-oxide nanoparticles and products including the siloxane-modified metal-oxide nanoparticles can be used to form various products, such as lenses or encapsulants for making various devices, such as, but not limited to, light emitting diodes. Such products generally have increased optical efficiency relative to conventional products.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a graph illustrating a gel permeation chromatography (GPC) curve of Example 1;

FIG. 2 is a graph illustrating a GPC curve of Example 2;

FIG. 3 is a graph illustrating a GPC curve of Example 4;

FIG. 4 is a graph illustrating a ²⁹Si nuclear magnetic resonance (NMR) curve of Example 1;

FIG. 5 is a graph illustrating a ²⁹Si NMR curve of Example 2;

FIG. 6 is a graph illustrating a ²⁹Si NMR curve of Example 3;

FIG. 7 is a graph illustrating a ²⁹Si NMR curve of Example 4;

FIG. 8 is a graph illustrating a ¹³C NMR curve of Example 4;

FIG. 9 is a graph illustrating a ¹H NMR curve of Example 4;

FIG. 10 is a graph illustrating an infrared (IR) spectra curve of Example 1; and

FIG. 11 is a graph illustrating an IR spectra curve of Example 2.

### DETAILED DESCRIPTION OF THE INVENTION

The present invention provides methods of modifying metal-oxide nanoparticles. The modified metal-oxide nanoparticles of the present invention are useful for incorporation into various types of siloxane compositions or matrices. For example, the siloxane compositions including the modified metal-oxide nanoparticles can be used to form optical devices, such as encapsulants for light emitting diodes (LEDs).

The siloxane compositions can be of any type known in the art. Examples of suitable siloxane compositions, for purposes of the present invention, are disclosed in U.S. Patent Application No. 61/420,910 filed concurrently with the subject application, U.S. Patent Application No. 61/420,916 filed concurrently with the subject application, and U.S. Patent Application No. 61/420,921 filed concurrently with the subject application, the disclosures of which are incorporated by reference in their entirety, and collectively referred to hereinafter as the incorporated references. Other examples of suitable siloxane compositions, for purposes of the present invention, are commercially available from Dow Corning Corporation of Midland, Mich.

In embodiments employing one or more of the aforementioned siloxane compositions, the modified metal-oxide nanoparticles of the present invention can be used completely in place of, as a portion of, or in addition to, the metal-oxide nanoparticles described in the incorporated references, e.g. in place of the disclosed TiO₂ particles. It is to be appreciated that the present invention is not limited to any particular siloxane composition or use of the modified metal-oxide nanoparticles.

Surprisingly, it was discovered that the modified metal-oxide nanoparticles of the present invention impart excellent physical properties, such as increased refractive index (RI), relative to conventional metal-oxide nanoparticles. Without being bound or limited to any particular theory, it is believed that there is a certain amount of Si—O-M and/or Si—O[MOₓ] “bonding” within the modified metal-oxide nanoparticles, where M is the metal of the metal-oxide, e.g. Zr or Ti. Part of this belief comes from gel permeation chromatography (GPC) testing where a different signal was discovered relative to base or raw siloxane and metal-oxide materials. It is to be appreciated that, depending on the embodiment, a portion or all of the metal-oxide nanoparticles may not be physically bonded to Si—O, as described above.

The present invention generally provides four general methods of preparing the modified metal-oxide nanoparticles, hereinafter referred to simply as the modified nanoparticles. By “modified”, it is meant that some to all of the nanoparticles include a surface coating of siloxane which may partially or completely encapsulate the nanoparticles. Thickness of the surface coating may be uniform or may vary. It is to be appreciated that one or more discrete nanoparticles may be encapsulated by the surface coating, for example, the modified nanoparticles may include a plurality of individual nanoparticles each individually surface coated by siloxane and/or a plurality of two or more nanoparticles collectively surface coated by siloxane. By “nanoparticles”, it is meant that the modified nanoparticles are in the nanometer (nm) scale prior to conducting the respective modification method, such that the resulting modified nanoparticles themselves may be of the nanometer, smaller, and/or larger, scale, based on mean particle diameter (D50). It is to be appreciate that the modified nanoparticles can have a narrow or wide particle distribution, and can have one or more modes. Typically, at least a portion of each method is conducted in a vessel, such as a reaction vessel, which is described further below. Each of the methods will now be described in greater detail immediately below.

In a first embodiment, the method of forming the modified nanoparticles comprises the step of providing (a) an alkoxysilane having at least one aryl group per molecule, (b) an organosiloxane having at least at least two alkenyl groups per molecule, (c) an acidic catalyst, (d) water, (e) a basic catalyst, (f) metal-oxide nanoparticles, and optionally, (g) a silane having at least one alkenyl group per molecule. Each of the components can be provided by various methods understood in the art, such as by bucket, drum, tote, pipe, etc.

Amounts of the components can vary. In certain embodiments, the alkoxysilane (a) is used in an amount of from 0.1 to 90, the organosiloxane (b) of from 0.1 to 90, the acidic catalyst (c) of from 0.001 to 5, the water (d) of from 0.1 to 95, the basic catalyst (e) of from 0.005 to 5, the metal oxide nanoparticles (f) of from 0.1 to 90, and the silane (g) of from 0 to 90, wt. %, each based on 100 parts by weight of all of the components combined. It is to be appreciated that various combinations of these components, and amounts thereof, can be used.

The alkoxysilane can be any type of alkoxysilane known in the art, provided that the alkoxysilane includes at least one aryl group. Suitable aryl groups for purposes of the present invention include, but are not limited to, phenyl and naphthyl groups; alkaryl groups, such as tolyl and xylyl groups; and aralkyl groups, such as benzyl and phenethyl groups. In certain embodiments, the aryl group is a phenyl (Ph) group. Suitable alkoxy groups include, but are not limited to, methoxy groups, ethoxy groups, propoxy groups, etc. In certain embodiments, the alkoxy group(s) of the alkoxysilane is methoxy.

Typically, the alkoxysilane is a trialkoxysilane for imparting branching. Specific examples of suitable trialkoxysilanes include, but are not limited to, MePhSi(OMe)₃, PhSi(OEt)₃, and PhSi(OMe)₃, where Et is an ethyl group and Me is a methyl group. In one embodiment, the alkoxysilane is a MePhSi(OMe)₃, such as p-tolyl-trimethoxysilane. In another embodiment, the alkoxysilane is PhSi(OMe)₃. Other suitable alkoxysilanes, for purposes of the present invention, are described in the incorporated references, and/or are commercially available from Dow Corning Corporation.

The organopolysiloxane can be any type of organopolysiloxane known in the art. Typically, the organopolysiloxane is a functional disiloxane, for imparting functional groups and molecular weight control. The organopolysiloxane may have various functional groups, such as alkenyl groups. In one embodiment, the organosiloxane is (ViMe₂SO₂O, where Vi is a vinyl group. Other suitable organopolysiloxanes, for purposes of the present invention, are described in the incorporated references, and/or are commercially available from Dow Corning Corporation.

The acidic catalyst can be any type of acidic catalyst known in the art. Examples of suitable acids include, but are not limited to, hydrochloric acid, nitric acid, sulfuric acid, phosphoric acid, formic acid, acetic acid, trifluoroacetic acid, methanesulfonic acid, trifluoromethanesulfonic acid, benzenesulfonic acid, p-toluenesulfonic acid, chlorosilane, and early transition metal-oxide solutions.

The basic catalyst can be any type of basic catalyst known in the art. Examples of suitable bases include, but are not limited to, ammoniumhydroxide, tetramethyl ammonium hydroxide (TMAH), pyridine, trimethylamine, triethylamine, dimethylaminopyridine, 1,8-diazabicyclo[5,4,0]decene-7, 1,5-diazabicyclo[4,3,0]nonene-5, caesium hydroxide, tetramethylammonium silicate (TMAS), and potassium hydroxide (KOH). In one embodiment, the basic catalyst is KOH.

The silane can be any type of silane known in the art. Typically, the silane includes at least one functional group, such as an alkenyl group, for imparting the functional group. In certain embodiments, the silane is a chlorosilane. In one embodiment, the silane is ViMe₂SiCl. Other suitable silanes, for purposes of the present invention, are described in the incorporated references, and/or are commercially available from Dow Corning Corporation.

The metal-oxide nanoparticles can be any type of metal-oxide nanoparticles known in the art. The metal-oxide nanoparticles are typically in the size range of from 1 to 100, alternatively from 2 to 70, alternatively from 2 to 40, alternatively from 2 to 20, nm mean particle diameter (D50). Typically, the metal-oxide nanoparticles are ZrO₂ nanoparticles, TiO₂ nanoparticles, or a combination thereof. In one embodiment, the metal-oxide nanoparticles are ZrO₂ nanoparticles. Suitable metal-oxide nanoparticles, for purposes of the present invention, are commercially available from Sumitomo Osaka Cement Co., Ltd. of Tokyo, Japan. Other suitable metal-oxide nanoparticles, for purposes of the present invention, are described in the incorporated references.

The metal-oxide nanoparticles can be included in a sol, or colloidal dispersion, such as a dispersion of ZrO₂ nanoparticles in a liquid, e.g. water, toluene, etc. In certain embodiments, the sol also includes modifiers, such as surfactants. If the sol is employed, it can have various wt % solids, such as from 3 to 75, alternatively from 3 to 50, alternatively from 3 to 30, alternatively 10, wt % metal-oxide nanoparticles, each based on 100 parts by weight of the sol. In certain embodiments, the sol includes 10 wt % ZrO₂ in solvent, e.g. toluene or water, and has a mean particle diameter (D50) of 7 nm. In certain embodiments, the sol further includes a surfactant, which may be present in various amounts, such as from 0 to 20, alternatively 0 to 10, alternatively 0 to 7, wt %, each based on 100 parts by weight of the sol. It is believed that if certain water-based sols are employed, the nanoparticles can be stabilized by pH, such that a surfactant is not necessary for purposes of stabilization. In some of these embodiments, the metal-oxide nanoparticles are stabilized with an acidic component, such as acetic acid. Suitable sols, for purposes of the present invention, are commercially available from Sumitomo Osaka Cement Co., Ltd., such as NZD-3001A and NZD-8J61. Some of these sols may also be referred to in the art as Nano-ZrO₂ dispersions.

The method further comprises the step of reacting the alkoxysilane (a) and the organosiloxane (b), in the presence of the acidic catalyst (c), the water (d), and optionally, the metal-oxide nanoparticles (0, to form an intermediate composition. The intermediate composition includes monomers having hydroxyl groups. In certain embodiment, all or a portion of the metal-oxide nanoparticles are present during this step. In another embodiment, none of the metal-oxide nanoparticles are present during this step.

In this step, both the alkoxysilane and the organosiloxane are hydrolyzed such that they include one or more hydroxyl groups, more specifically, Si—OH or silanol groups. For example, if the alkoxysilane is PhSi(OMe)₃, it is typically fully hydrolyzed to become PhSi(OH)₃ and three molecules of methanol are also formed, such that the intermediate composition comprises at least PhSi(OH)₃ and methanol. The methanol may be removed from the intermediate composition by various methods, such as by distillation. Further if the organopolysiloxane is (ViMe₂Si)₂O, then one of the Si—O bonds is typically cleaved, such that the intermediate composition further comprises two ViMe₂SiOH molecules for each molecule of (ViMe₂SO₂O. This reaction step may generally be referred to in the art as a hydrolysis reaction. It is to be appreciated that there may be some instances where hydrolysis is not fully complete, e.g. residual alkoxy groups may remain.

Typically, heat is applied during this step, over a period of time, to facilitate the reaction, e.g. for a time sufficient to hydrolyze most to all of the alkoxy groups of the alkoxysilane. Suitable temperatures can vary, and may range from room temperature (room, 23° C.) to 95° C., alternatively from room to 85° C., alternatively from room to 70° C. Time of reaction can vary, and may range from 1 to 24, alternatively from 1 to 12, alternatively from 1 to 6, alternatively from 1 to 3, hours. This step can be carried out with or without stiffing of the components, but typically with stirring to facilitate the reaction.

The method further comprises the step of reacting the monomers in the presence of the basic catalyst (e), and optionally, the metal-oxide nanoparticles (f), to form a silsesquioxane resin having residual hydroxyl groups. In certain embodiments, all or a portion of the metal-oxide nanoparticles are present during this step. In another embodiment, none of the metal-oxide nanoparticles are present during this step. Regardless of the embodiment, the metal-oxide nanoparticles need to be present during at least one of the two reacting steps described immediately above in order to incorporate the same with the silsesquioxane resin. As alluded to above, the metal-oxide nanoparticles can be employed in their entirety in one of the two reacting steps, or apportioned in various fractions between the two reacting steps.

In this step, the basic catalyst typically neutralizes the acidic catalyst; however, in certain embodiments, a different type of base may be used merely for neutralization. In order to drive the reaction, water is removed such that the reaction is a condensation reaction, with the monomers losing hydroxyl groups and cross linking with one another to form siloxane bonds, i.e., Si—O—Si bonds. Said another way, water is removed from the intermediate composition for inducing the condensation reaction. Typically, the reaction is continued until water can no longer be removed from the intermediate composition. This reaction step may generally be referred to in the art as a condensation or equilibration reaction. It is to be appreciated that there may be some or many instances where condensation is not fully complete, e.g. residual hydroxyl groups may remain, as described further below.

Typically, heat is applied during this step, over a period of time, to facilitate the reaction, e.g. for a time sufficient to cross link most to all of the monomers. Suitable temperatures can vary, and may range from room temperature (room, 23° C.) to 135° C., alternatively from room to 125° C., alternatively from 60° C. to 110° C. In another embodiment, the upper ranges are increased, such as up to 138 to 144° C. Such temperature ranges can also vary based on the presence or absence of a solvent, such as toluene or xylene, and based on the presence or absence of a catalyst, such as TMAH. For example, in certain embodiments, where TMAH is used as a catalyst, 80° C. is maintained for a period of time, and then the temperature is increased to 110° C. to thermally decompose, i.e., remove, the TMAH. Suitable time periods are as described above with description of the first reaction step. This step can be carried out with or without stirring of the components, but typically with stirring to facilitate the reaction.

The method can further comprise the step of reacting the silsesquioxane resin with the silane (g) to form the modified nanoparticles. Without being bound or limited to any particular theory, it is believed that bonding of the nanoparticles to the resin can be increased based on the presence of T units proximal to the nanoparticles more so than M units proximal to the nanoparticles. These modified nanoparticles typically have residual alkenyl groups, such as vinyl groups. The residual alkenyl groups can be used for subsequent reaction, such as during incorporation of the modified nanoparticles into a siloxane composition and/or formation of an encapsulant from a siloxane composition including the modified nanoparticles of the present invention.

In this step, the silane typically serves as an end capper for residual hydroxyl groups that did not cross link, and/or the silane neutralizes free hydroxyl groups. It is to be appreciated that the silane (g) need not be necessarily used, depending on embodiment. The silane itself can also impart the residual alkenyl groups of the modified nanoparticles, much like certain embodiments of the organopolysiloxane. If any water and/or solvent remains along with the modified nanoparticles, the same can be removed or left for subsequent formulation. One way to remove residual water is use of a drying agent, such as MgSO₄; whereas solvent, such as toluene, can be simply flashed off.

As introduced above, the modified nanoparticles include a silsesquioxane resin. Typically, the modified nanoparticles comprise a homogenous mixture of the nanoparticles and the silsesquioxane resin, where it is believed that some portions of the nanoparticles are bonded to some portions of the silsesquioxane resin as introduced above. Silsesquioxane resins are generally understood by those skilled in the art, and include a plurality of the same or different “T units” of the general structure RSiO_{3/2}, where R is typically an organic group, such as an aryl group, an alkyl group, etc., such as a phenyl group imparted by the alkoxysilane. In certain embodiments, the silsesquioxane resin formed by the method described above, is illustrated by the general formula (1):

^{Vi}Mₐ^{PhMe}D_{b}^{Ph}T_{c} (1)

where a is from 0.005 to 0.20, b is from 0.0 to 0.40, c is from 0.40 to 0.90, and a+b+c=1.

The molar amounts of a, b, and c can be controlled by the amount of each component employed. In certain embodiments, the amount of the trialkoxysilane, organodisiloxane, and silane will impart the M, D and T units illustrated above. For example, the trialkoxysilane will generally impart the T units, and the disiloxane, and optionally, the silane, will generally impart the M units. The D units are typically only present in minor amounts, if at all, based on internal rearrangements. As described above, it is believed that a portion of the metal-oxide nanoparticles are “bonded” to the silsesquioxane resin. For example, certain embodiments of the modified nanoparticles may be illustrated by the general formula (2):

^{Vi}Mₐ^{PhMe}D_{b}^{Ph}T_{c}[ZrO₂]_{d} (2)

where a+b+c=1, a, b, and c are as described above, and d is from 0.05 to 0.90, alternatively from 0.10 to 0.80.

Without being bound or limited by any particular theory, it is believed that the T units may comprise up to three subunits of T¹, T², and T³, with the superscripts indicating the actual number of siloxane bonds, remainder being residual silanol groups. For example, c can actually include sub-amounts of c₁, c₂, and c₃, illustrated further by the general formula (3):

^{Vi}Mₐ^{PhMe}D_{b}^{Ph}T¹_{c1}T²_{c2}T³_{c3} (3)

where c1+c2+c3=c, a+b+c=1, and a, b, and c are as described above. T¹ would have one Si—O—Si (siloxane) bond, two SiOH (silanol) groups, and a Ph group, T² would have two Si—O—Si bonds, one SiOH group, and a Ph group, and T³ would have three Si—O—Si bonds and a Ph group. As such, the silsesquioxane resins of the present invention generally have complex, cage-like structures with various functional and non-functional groups.

In a second embodiment, the method of forming the modified nanoparticles comprises the step of providing (a) an acidic catalyst, (b) metal-oxide nanoparticles, (c) water, (d) an alcohol, (e) a solvent, and (f) an alkoxysilane having at least one acryl group per molecule. The solvent is different than the water and alcohol. Each of the components can be provided by various methods understood in the art, such as by bucket, drum, tote, pipe, etc. Suitable acidic catalysts, metal-oxide nanoparticles, and solvents are as described and exemplified above with description of the first embodiment.

Amounts of the components can vary. In certain embodiments, the acidic catalyst (a) is used in an amount of from 0.001 to 5, the metal oxide nanoparticles (b) of from 0.5 to 70, the water (c) of from 1 to 99, the alcohol (d) of from 0.5 to 70, the solvent (e) of from 0.5 to 70, and the alkoxysilane (f) of from 0.1 to 50, wt. %, each based on 100 parts by weight of all of the components combined. It is to be appreciated that various combinations of these components, and amounts thereof, can be used.

The alcohol can be any type of alcohol known in the art. Suitable alcohols include, but are not limited to methanol, isopropanol, ethanol, butanol, etc., and combinations thereof. In one embodiment, the alcohol is methanol. It is believed that the alcohol, as a hydrophilic solvent, is useful for imparting homogeneity during the method.

The alkoxysilane may be any alkoxysilane known in the art, provided that the alkoxysilane has at least one acryl group per molecule. In certain embodiments, the alkoxysilane is selected from the group of acryloxypropyltrimethoxysilane, methacryloxypropyltrimethoxysilane, or a combination thereof. Other suitable alkoxysilanes, for purposes of the present invention, are described in the incorporated references, and/or are commercially available from Dow Corning Corporation.

The method further comprises the step of combining the acidic catalyst (a), the metal-oxide nanoparticles (b), and the water (c) to form a first precursor composition. This step is useful for getting the aforementioned components into an acidic solution, i.e., the first precursor composition.

The method further comprises the step of combining the alcohol (d), the solvent (e), and the alkoxysilane (f) to form a second precursor composition. This step is useful for getting the aforementioned components into solution, i.e., the second precursor composition.

The method further comprises the step of reacting the first and second precursor compositions to form the modified nanoparticles. These modified nanoparticles typically have residual acryl groups, such as (meth)acryl groups. The residual acryl groups can be used for subsequent reaction, and generally have good compatibility with aqueous media.

In this step, the alkoxysilane is hydrolyzed such that it includes one or more hydroxyl groups, more specifically, Si—OH or silanol groups. It is to be appreciated that there may be some instances where hydrolysis is not fully complete, e.g. residual alkoxy groups may remain.

Typically, heat is applied during this step, over a period of time, to facilitate the reaction, e.g. for a time sufficient to hydrolyze most to all of the alkoxy groups of the alkoxysilane. Suitable temperatures can vary, and may range from room temperature (room, 23° C.) to 95° C., alternatively from room to 85° C., alternatively from room to 70° C. Time of reaction can vary, and may range from 1 to 24, alternatively from 1 to 12, alternatively from 1 to 6, alternatively from 1 to 3, hours. This step can be carried out with or without stiffing of the components, but typically with stirring to facilitate the reaction.

In a third embodiment, the method of forming the modified nanoparticles comprises the step of providing (a) a sol comprising i) metal-oxide nanoparticles, ii) an acidic component, and iii) water, (b) an alcohol, (c) an alkoxysilane, and (d) a basic catalyst. Each of the components can be provided by various methods understood in the art, such as by bucket, drum, tote, pipe, etc. Suitable metal-oxide nanoparticles, alcohols, alkoxysilanes, and basic catalysts are as described and exemplified above with description of the first and second embodiments.

Amounts of the components can vary. In certain embodiments, the sol (a) is used in an amount of from 0.5 to 90, the alcohol (b) of from 0.5 to 70, the alkoxysilane (c) of from 0.1 to 50, and the basic catalyst (d) of from 0.005 to 5, wt. %, each based on 100 parts by weight of all of the components combined. It is to be appreciated that various combinations of these components, and amounts thereof, can be used.

The alkoxysilane can be any type of alkoxysilane known in the art. Typically, the alkoxysilane is a trialkoxysilane for imparting branching. Specific examples of suitable trialkoxysilanes include, but are not limited to, MePhSi(OMe)₃, PhSi(OEt)₃, and PhSi(OMe)₃. In one embodiment, the alkoxysilane is a MePhSi(OMe)₃, such as p-tolyl-trimethoxysilane. In another embodiment, the alkoxysilane is PhSi(OMe)₃.

The sol may be any type of sol known in the art, provided it includes metal-oxide nanoparticles and water. The sol may already include the acidic component or have the acidic component added thereto at a later time. For example, some commercially available sols include acid components for stabilization of the dispersed metal-oxide nanoparticles.

As alluded to above, the sol typically includes ZrO₂ nanoparticles and/or TiO₂ nanoparticles. The sol can have various wt % solids, such as from 5 to 75, alternatively from 5 to 50, alternatively from 5 to 30, wt % metal-oxide nanoparticles, each based on 100 parts by weight of the sol. Suitable sols, for purposes of the present invention, are commercially available from Sumitomo Osaka Cement Co., Ltd. and from Tayca Corporation of Japan. Suitable acidic components are as described and exemplified above with description of the acidic catalysts in the first and second embodiments. In one embodiment, the acidic component is acetic acid.

The method further comprises the step of removing at least a portion of the water iii) from the sol (a) to obtain a particle composition. Typically, most to substantially all of the water is removed from the sol. The water may be removed by various methods understood in the art, such as by distillation, vacuum, etc. As such, in certain embodiments, the particle composition consists essentially of the metal-oxide nanoparticles and the acidic component. In these embodiments, it is believed that at least a portion of the metal-oxide nanoparticles, e.g. ZrO₂ nanoparticles, include at least a portion of the acidic component, e.g. acetic acid, as a surface treatment.

The method further comprises the step of mixing the alcohol (b) and the particle composition to form a transitional composition. This step is useful for dispersing the “surface treated” metal-oxide nanoparticles into solution, i.e., the transitional composition.

The method further comprises the step of reacting the alkoxysilane (c) and the transitional composition to form monomers having hydroxyl groups.

In this step, the alkoxysilane is hydrolyzed such that it includes one or more hydroxyl groups, more specifically, Si—OH or silanol groups. For example, if the alkoxysilane is PhSi(OMe)₃, it is typically fully hydrolyzed to become PhSi(OH)₃ and three molecules of methanol are also formed. The methanol may be removed by various methods, such as by distillation. This reaction step may generally be referred to in the art as a hydrolysis reaction. It is to be appreciated that there may be some instances where hydrolysis is not fully complete, e.g. residual alkoxy groups may remain.

Typically, heat is applied during this step, over a period of time, to facilitate the reaction, e.g. for a time sufficient to hydrolyze most to all of the alkoxy groups of the alkoxysilane. Suitable temperatures can vary, and may range from room temperature (room, 23° C.) to 95° C., alternatively from room to 85° C., alternatively from room to 70° C. Time of reaction can vary, and may range from 1 to 24, alternatively from 1 to 12, alternatively from 1 to 6, alternatively from 1 to 3, hours. This step can be carried out with or without stirring of the components, but typically with stirring to facilitate the reaction.

The method further comprises the step of reacting the monomers in the presence of the basic catalyst (d) to form the siloxane-modified metal-oxide nanoparticles. In this step, the basic catalyst typically neutralizes the acidic catalyst; however, in certain embodiments, a different type of base may be used merely for neutralization. In certain embodiments, the basic catalyst is TMAH and/or TMAS.

In order to drive the reaction, water is removed such that the reaction is a condensation reaction, with the monomers losing hydroxyl groups and cross linking with one another to form siloxane bonds, i.e., Si—O—Si bonds. Said another way, water is removed for inducing the condensation reaction. Typically, the reaction is continued until water can no longer be removed. This reaction step may generally be referred to in the art as a condensation or equilibration reaction.

Typically, heat is applied during this step over a period of time to facilitate the reaction, i.e., for a time sufficient to cross link many if not all of the monomers. Suitable temperatures can vary, and may range from room temperature (23° C.) to 135, alternatively from room to 110, alternatively from 60 to 110, ° C. Suitable time periods are as described above with description of the first reaction step. This step can be carried out with or without stirring of the components, but typically with stirring. Sufficient heat should be applied to decompose the basic catalyst to prevent salt formation.

In a fourth embodiment, the method of forming the modified nanoparticles comprises the step of providing (a) linear- and/or cyclic-siloxane oligomers having residual hydroxyl groups, (b) metal-oxide nanoparticles, and (c) a basic catalyst. Each of the components can be provided by various methods understood in the art, such as by bucket, drum, tote, pipe, etc. Suitable metal-oxide nanoparticles and basic catalysts are as described and exemplified above with description of the first, second, and third embodiments.

Amounts of the components can vary. In certain embodiments, the linear- and/or cyclic-siloxane (a) is used in an amount of from 0.5 to 90, the metal oxide nanoparticles (b) of from 1 to 80, and the basic catalyst (c) of from 0.005 to 5, wt. %, each based on 100 parts by weight of all of the components combined. It is to be appreciated that various combinations of these components, and amounts thereof, can be used.

The linear- and/or cyclic-siloxane oligomers can be any oligomers known in the art, provided they include at least one residual hydroxyl group. Examples of suitable oligomers are hydroxyterminated phenylmethylsiloxanes. Other suitable oligomers, for purposes of the present invention, are described in the incorporated references, and/or are commercially available from Dow Corning Corporation.

The method further comprises the step of reacting the oligomers (a) in the presence of the metal-oxide nanoparticles (b) and the basic catalyst (c) to form the siloxane-modified metal-oxide nanoparticles. In order to drive the reaction, water is removed such that the reaction is a condensation reaction, with the oligomers losing hydroxyl groups and cross linking with one another to form siloxane bonds, i.e., Si—O—Si bonds, and therefore, larger polymers. Said another way, water is removed for facilitating induction of the condensation reaction. Typically, the reaction is continued until water can no longer be removed. This reaction step may generally be referred to in the art as a condensation or equilibration reaction. It is to be appreciated that there may be some or many instances where condensation is not fully complete, e.g. residual hydroxyl groups may remain.

The methods described herein can be carried out by employing various vessels understood in the art, such as use of reaction vessels. The vessels typically include heat exchange means, such as heating/cooling lines, jackets, etc. A lab-scale example of a suitable setup for employing the methods of the present invention, and for forming the modified nanoparticles, includes a three neck round bottomed flask equipped with a stirrer, an addition funnel, a thermometer, a Dean-Stark trap, and heating and cooling means. It is to be appreciated that the present invention is not limited to a particular setup. One skilled in the art may scale up such a setup for manufacturing purposes.

Solids content of each of the reaction compositions can be adjusted before, during, or after the reaction steps with addition of an inert solvent, such as toluene, xylene, etc. By “inert”, it is merely meant that the solvent itself does not chemically participate in the reaction(s). The solvent(s) can later be removed, e.g. by stripping, or left for subsequent formulation, such as for incorporation of the modified nanoparticles into a siloxane composition.

The following examples, illustrating the methods and modified nanoparticles of the present invention, are intended to illustrate and not to limit the invention.

### EXAMPLES

Examples of the modified nanoparticles were prepared. Specifically, Examples 1, 2, and 3 were prepared. The methods of preparing Examples 1, 2, and 3 are related to the first embodiment of the present invention. Each of the examples in explained in detail immediately below.

### Example 1

Into a three neck round bottomed flask equipped with a stirrer, addition funnel, thermometer, and Dean Stark trap with a condenser was charged 14.88 g PhSi(OMe)₃ and 12.30 g of sol. The sol is zirconium (ZrO₂) sol, and includes 10 wt % ZrO₂ nanoparticles in toluene, along with a modifier(s). The sol has a solid content after 150° C. for 1 hr, of 16.6 wt %. Makeup of the modifier is proprietary and therefore unknown, but the modifier is believed to be a surfactant, which is present in an amount of about 7 wt %. The nanoparticles are 7 nm in actual diameter. The sol is somewhat hazy in appearance. The sol is commercially available from Sumitomo Osaka Cement Co., Ltd. Without being bound or limited to any particular theory, it is believed that the presence of the modifier, e.g. surfactant, in the sol is especially useful for forming subsequent homogenous compositions.

Next, a solution comprising 4.21 g water, 1.47 g (ViMe₂Si)₂O, and 0.042 g acidic catalyst was added drop-wise to the flask to form a mixture. The acidic catalyst is trifluoromethanesulfonic acid. The mixture was heated at 66° C. for 2.5 hours. The temperature was then raised to maintain a good reflux at 74° C. and methanol was taken out from the Dean Stark trap, the bottom of the condenser.

96 mg basic catalyst was added to neutralize the acidic catalyst, and an additional 44 mg basic catalyst was added for the next equilibration catalyst. The basic catalyst is KOH. Solvent was added to the mixture to adjust to 50 wt % solids. The solvent is toluene. The mixture was stirred for 8 hours for equilibration. During this time, the temperature was raised to reflux and condensed water was taken out from the Dean Stark trap, the bottom of the condenser, until there is no water coming out.

The bodied resin was cooled to room temperature and one drop ViMe₂SiCl was stirred in. The resin solution was washed, dried with MgSO₄, and centrifuged. A rotovap was used to adjust the solids content of the resin solution to 71%. The solution is somewhat hazy in appearance, similar to the sol. Completely removing the solvent from the solution left 2.873 g dry flake of the product, i.e., resin/modified nanoparticles. The sought after product was ^{Vi}M_{0.15}^{Ph}T_{0.75}[ZiO₂]_{0.10}.

The product of Example 1 was tested via IR spectrospy, GPC, and NMR, by methods understood in the art. Regarding IR, formation of Si—O—Zr was not verified (930 cm⁻¹) in the product. However, OH stretching was observed. Regarding GPC, the GPC molecular weight of the product was similar to comparative ^{Vi}M^{Ph}T(Q) resins. However, these comparative resins showed bimodal GPC curves, while the product of Example 1 showed a mono-modal curve. Regarding NMR, unlike the comparative ^{Vi}M^{Ph}T(Q) resins, the product of Example 1 contained a large amount of SiOH, 21.6 mole % of ^{Ph}T² and even 0.4 mole % of ^{Ph}T¹. These results, as well as the different GPC pattern, suggest that the product synthesis reaction(s) is affected by the presence of the ZrO₂. Regarding ²⁹Si NMR, using D₄ (octamethylcyclotetrasiloxane) as an internal standard gave a resin content per solid of 83.5 wt %. Vinyl content per solid was determined from this. Assuming that the rest of the solid is from ZrO₂ and that 50 wt % of the modifier is contained in the ZrO₂, a hypothesized composition for the product of Example 1 is ^{Vi}M_{0.138}^{PhMe}D_{0.003}^{Ph}T¹_{0.003}^{Ph}T²_{0.192}^{Ph}T³_{0.546}[ZrO₂]_{0.118}.

### Example 2

Example 2 is prepared in a similar manner as Example 1. The sought after product was ^{Vi}M_{0.15}^{Ph}T_{0.75}[ZiO₂]_{0.10}. Relative to Example 1, KOH equilibration was carried out for 16 hours in Example 2 rather than for 8 hours. In addition, after removing solvent, the product was a sticky solid, rather than a flakey solid.

The product of Example 2 was tested via IR spectrospy, GPC, and NMR, by methods understood in the art. Regarding IR, a relatively large absorption at 898 cm⁻¹ is observed. Formation of Si—O—Zr was not verified. Regarding GPC, the MW was much lower with multi-modal peaks relative to the product of Example 1. GPC testing generally includes use of CHCl₃, TSK gel XL-L. Regarding NMR, much more SiOH was present than in Example 1. Regarding ²⁹Si NMR, using D₄ as an internal standard gave a resin content per solid of 81.9 wt %. Vinyl content per solid was determined from this. Assuming that the rest of the solid is from ZrO₂ and that 50 wt % of modifier is contained in the ZrO₂, a hypothesized composition for the product of Example 2 is ^{Vi}M_{0.45}^{PhMe}D_{0.001}^{Ph}T¹_{0.013}^{Ph}T²_{0.399}^{Ph}T³_{0.310}[ZrO₂]_{0.132}.

NMR and other data for Examples 1 and 2 is illustrated in Tables 1 and 2 below.

TABLE 1

²⁹Si NMR Integr.

| Example | M | ^{PhMe}D | T¹ | T² | T³ | Q⁴ |
|---|---|---|---|---|---|---|
| #1 | 0.156 | 0.004 | 0.004 | 0.216 | 0.620 | — |
| #2 | 0.167 | 0.001 | 0.015 | 0.460 | 0.357 | — |

TABLE 2

| Example | (1) | (2) | Hypothezized composition |
|---|---|---|---|
| #1 | 2.82 | 83.5 | ^{Vi}M_{0.138}^{PhMe}D_{0.003}^{Ph}T¹_{0.003}^{Ph}T²_{0.192}^{Ph}T³_{0.546}[ZrO₂]_{0.118} |
| #2 | 2.90 | 81.9 | ^{Vi}M_{0.145}^{PhMe}D_{0.001}^{Ph}T¹_{0.013}^{Ph}T²_{0.399}^{Ph}T³_{0.310}[ZrO₂]_{0.132} |

(1) Vi content per entire solid (wt %)
(2) Resin content per solid (wt %)

### Example 3

Example 3 is prepared in a similar manner as Examples 1 and 2. The sought after product is ^{Vi}M_{0.15}^{Ph}T_{0.75}[TiO₂]_{0.10}. The sol is a titanium dioxide (TiO₂) sol, rather than a ZrO₂ sol. The sol includes 29.8 wt % TiO₂ nanoparticles in toluene. The nanoparticles are ˜15 to ˜25 nm in actual diameter. The sol is commercially available from Tayca Corporation of Japan.

The temperature of the mixture was raised to maintain a good reflux at 77.5° C. and methanol was taken out from the bottom of the condenser. KOH equilibration was carried out for 12 hours. The mixture is nuetralized with acetic acid. The product is filtered through Kyowado 500, a synthetic adsorbing material manufactured by Kyowa Chemical Industry Co., Ltd. No gelation occurred but the aggregation of TiO₂ appeared to increase, with a lot of white precipitate. The precipitate was removed by centrifugation.

The product of Example 3 was tested via NMR methods understood in the art. Regarding ²⁹Si NMR, using D₄ as an internal standard gave a resin content per solid of 95.2 wt %, but this value seemed erratic. A hypothesized composition for the product of Example 3, without TiO₂, is ^{Vi}M_{0.157}^{Ph}T¹_{0.006}^{Ph}T²_{0.379}^{Ph}T³_{0.458}.

In Examples 1-3, it is believed that the presence of residual Si—OH groups could be due to the interaction between Si—OH and ZrO₂ (or TiO₂) and/or because the KOH is killed by the acidity of ZrO₂ (or TiO₂).

Composition and GPC data for Examples 1-3 is illustrated in Table 3 below.

TABLE 3

| Example | Composition based on ²⁹Si NMR | GPC Mw | GPC Mn |
|---|---|---|---|
| #1 | ^{Vi}M_{0.156}^{PhMe}D_{0.004}^{Ph}T_{0.840}ZrO2ₓ | 2190 | 1270 |
| #2 | ^{Vi}M_{0.167}^{PhMe}D_{0.001}^{Ph}T_{0.832}ZrO2ₓ | 1290 | 840 |
| #3 | ^{Vi}M_{0.157}^{Ph}T¹_{0.006}^{Ph}T²_{0.379}^{Ph}T³_{0.458} | — | — |

A product example was prepared using the product of Example 2.5 g of this material was cured using 0.57 g silphenylene with the H/Vi ratio of 1.1 at 100° C. for 1 hour and 200° C. for 1 hour to form a cured monolith. The cured monolith was cut into 5×5×5 mm cube and polished to form a prism for optical characterization. The n_{d} for this material was determined to be 1.56, which is considered to be an excellent RI value.

Another example of the modified nanoparticles was prepared. Specifically, Example 4 was prepared. The method of preparing Example 4 is related to the third embodiment of the present invention. Example 4 is explained in detail immediately below.

### Example 4

139.75 g of sol was dried under vacuum at 30° C. to form 17.57 g of particle composition. The sol is acetic acid stabilized ZrO₂ in water (10 wt % ZrO₂ aqueous solution), and is commercially available from Sumitomo Osaka Cement Co., Ltd. 4.0 g particle composition was reacted step-wise with 3.00 g of PhSi(OMe)₃ under the residual acetic acid condition in a 14.2 g methanol/1.58 g water/5.70 g toluene mixture. The mixture was heated at 66° C. for 1 hour. The temperature was cooled down to room temperature, followed by addition of 60 μL TMAH (26 wt % aqueous solution). Then, the temperature was gradually raised to 110° C. by addition of toluene during removal of methanol and water from the Dean Stark trap.

The temperature was cooled down to room temperature, followed by addition of 1.70 g vinyldimethylsilanol in cyclo-hexane (45 wt % solution), 1.97 g hydroxyterminated polyphenylmethylsiloxane (Mw=602), and 30 μL of TMAH aqueous solution, then the temperature was gradually raised to 80° C. and maintained for 2 hours, followed by the temperature increasing to 110° C. and maintained for 4 hours.

The bodied resin was cooled to room temperature. A rotovap was used to remove the solvent from the solution, which left 8.43 g of a dry highly viscous liquid of the product, i.e., resin-modified nanoparticles. The sought after product was ^{Vi}M_{0.03}D_{0.09}^{Ph}D_{0.18}^{Ph}T_{0.26}[ZiO₂]_{0.44}.

The obtained product is a highly viscous liquid containing a small amount of toluene with little MeO group, and was analyzed by ¹H, ¹³C, and ²⁹Si NMR in CDCl₃. The n_{d} for this material was determined to be 1.603, which is considered to be an excellent RI value. The product of Example 4 is readily dispersed in propylene glycol methyl ether acetate (PGMEA) to provide a stable translucent dispersion, but it was slowly precipitated in CDCl₃, which indicated that it may be unstable in a weak acid solution. The product of Example, in PGMEA, was also heated in an aluminum pan at 150° C. for 6 hours to produce clear transparent coatings without any cracks.

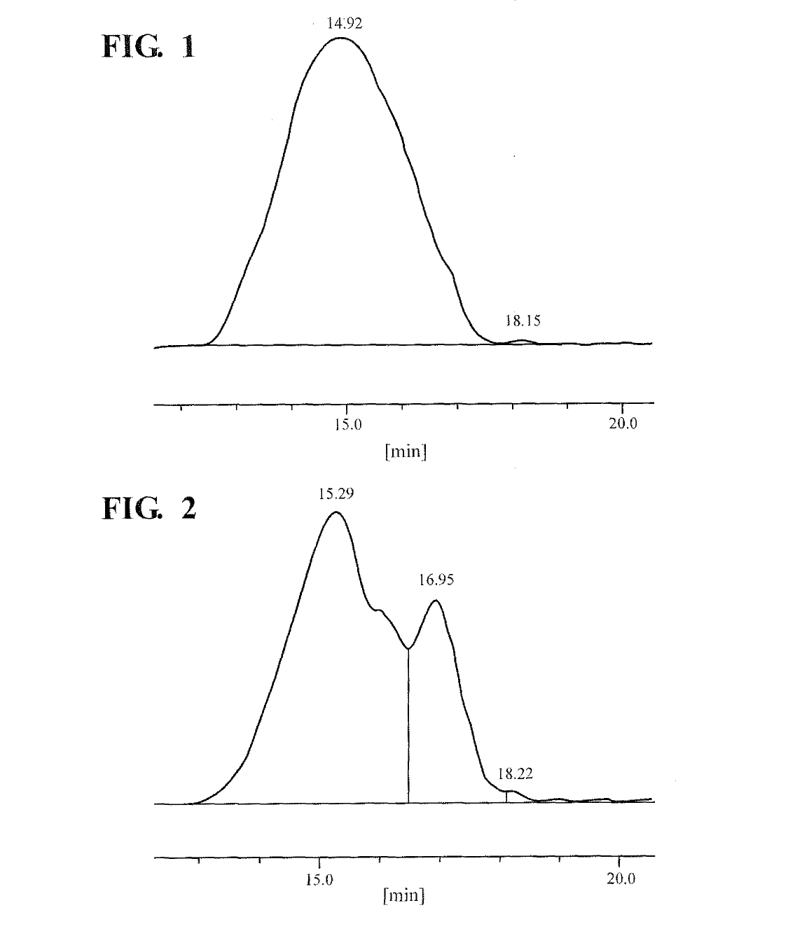

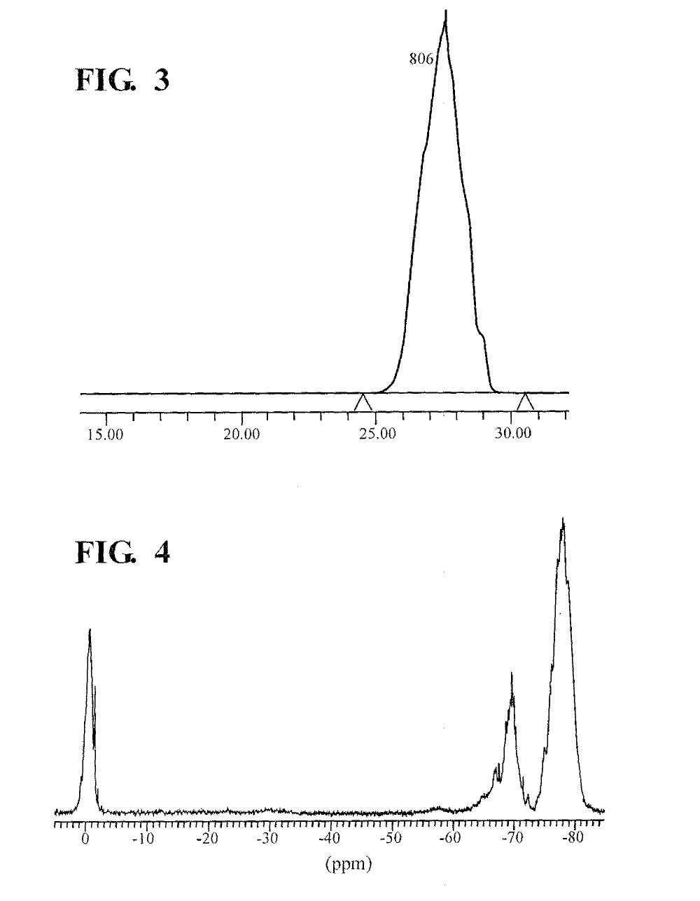

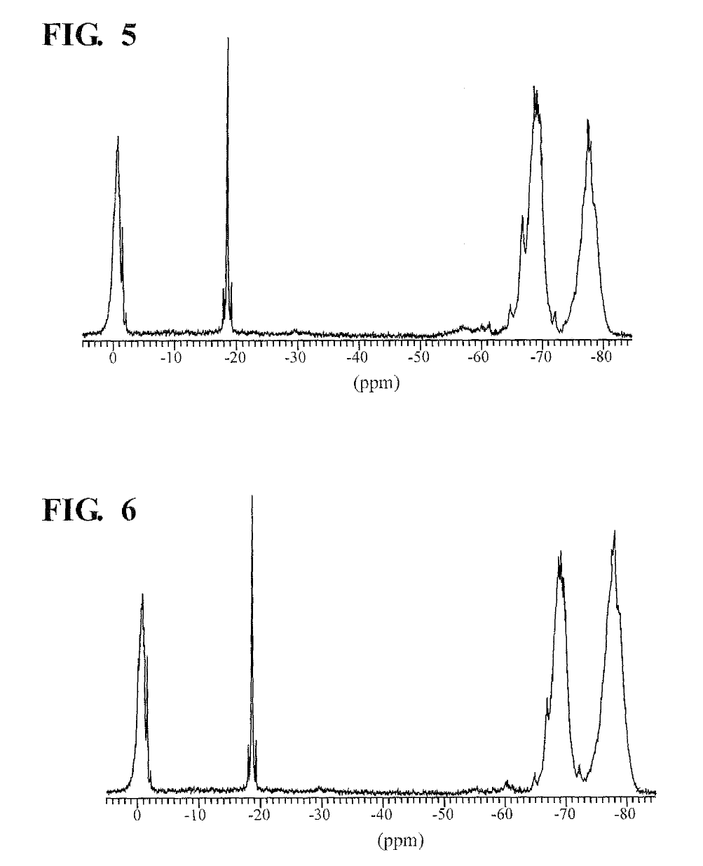

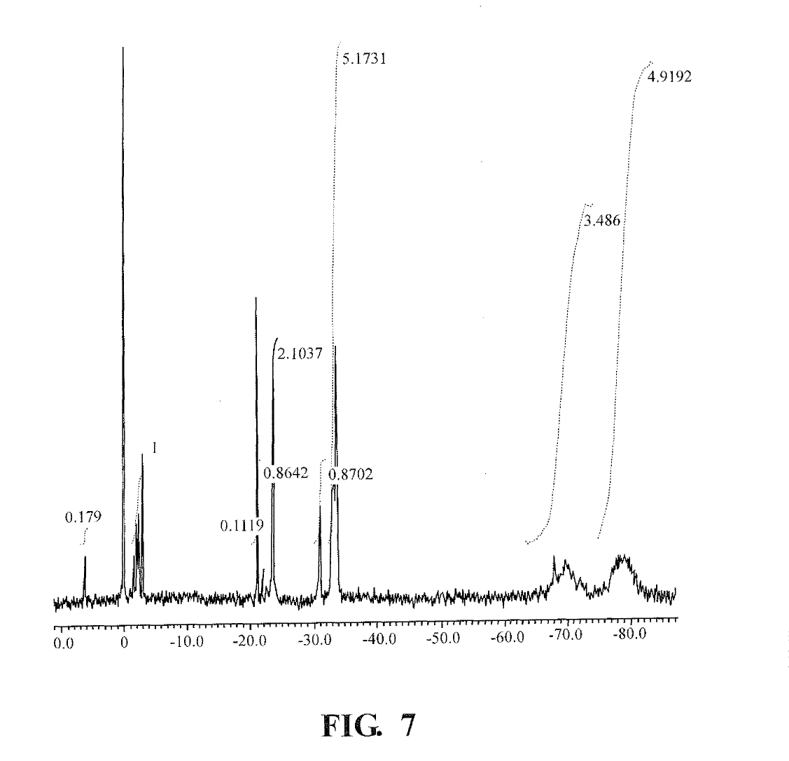

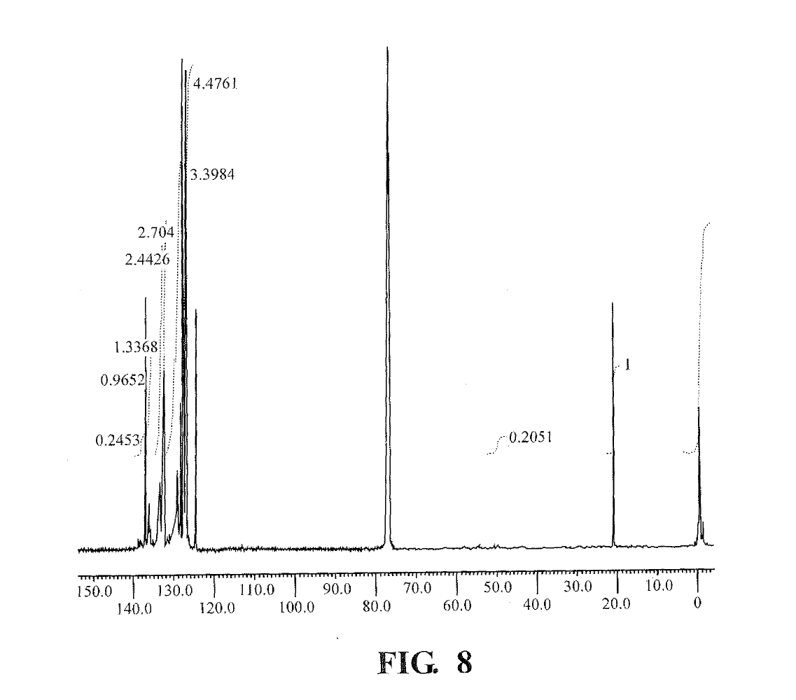

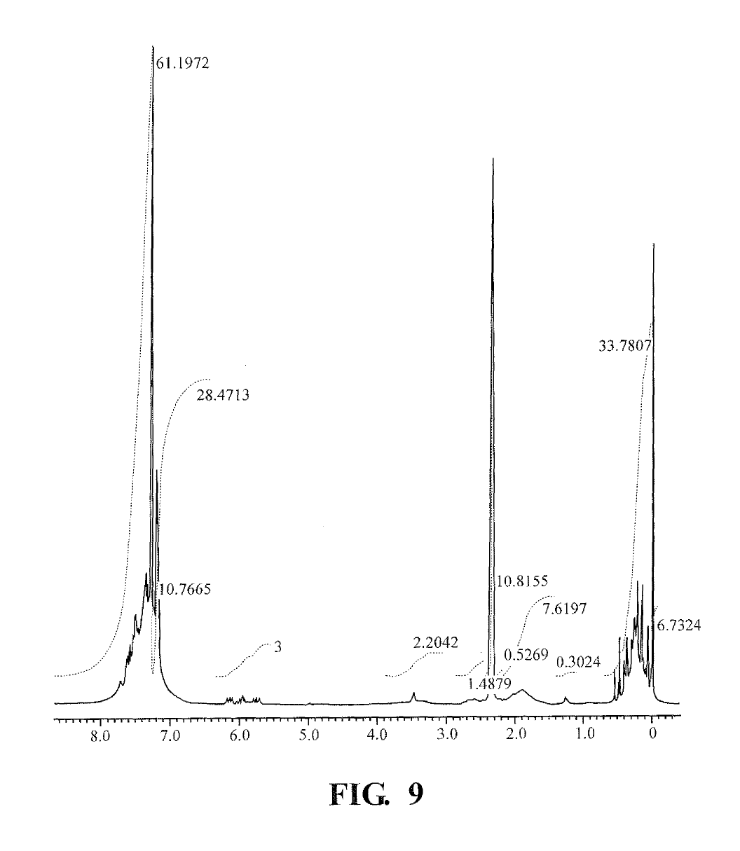

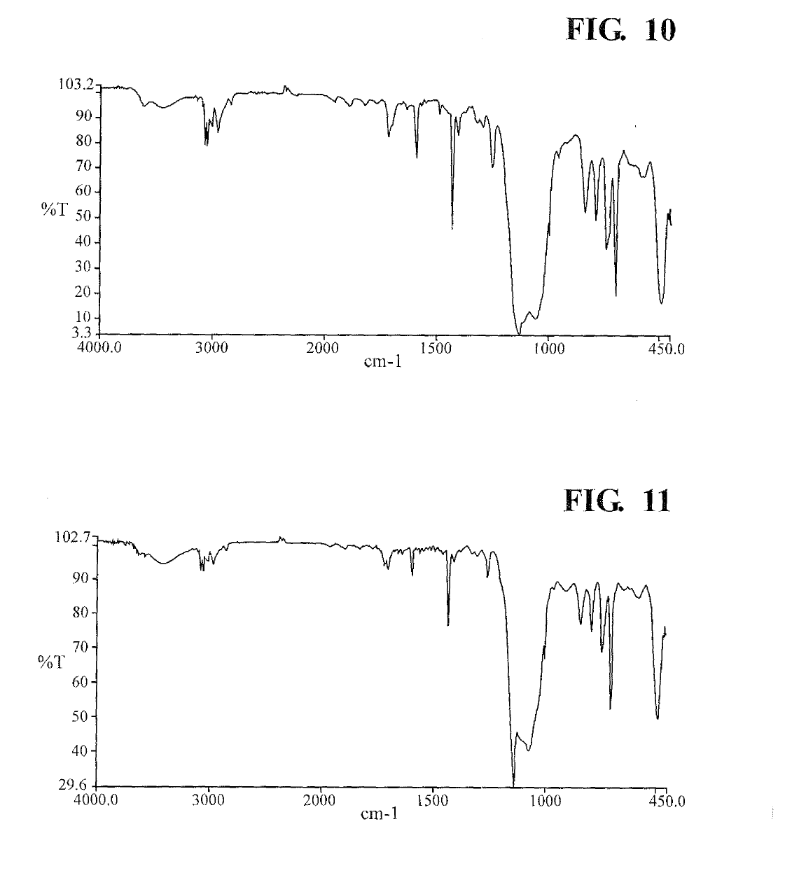

Referring now to the Figures, additional properties of the Examples described above can be better appreciated. FIG. 1 is a graph illustrating a gel permeation chromatography (GPC) curve of Example 1. FIG. 2 is a graph illustrating a GPC curve of Example 2. FIG. 3 is a graph illustrating a GPC curve of Example 4. FIG. 4 is a graph illustrating a ²⁹Si nuclear magnetic resonance (NMR) curve of Example 1. FIG. 5 is a graph illustrating a ²⁹Si NMR curve of Example 2. FIG. 6 is a graph illustrating a ²⁹Si NMR curve of Example 3. FIG. 7 is a graph illustrating a ²⁹Si NMR curve of Example 4. FIG. 8 is a graph illustrating a ¹³C NMR curve of Example 4. FIG. 9 is a graph illustrating a ¹H NMR curve of Example 4. FIG. 10 is a graph illustrating an infrared (IR) spectra curve of Example 1. FIG. 11 is a graph illustrating an IR spectra curve of Example 2.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims. The subject matter of all combinations of independent and dependent claims, both singly and multiply dependent, is herein expressly contemplated.

The present invention has been described herein in an illustrative manner, and it is to be understood that the terminology which has been used is intended to be in the nature of words of description rather than of limitation. Many modifications and variations of the present invention are possible in light of the above teachings. The invention may be practiced otherwise than as specifically described within the scope of the appended claims.

1. A method of forming siloxane-modified metal-oxide nanoparticles, said method comprising the steps of:
I) providing (a) an alkoxysilane having at least one aryl group per molecule, (b) an organosiloxane having at least two alkenyl groups per molecule, (c) an acidic catalyst, (d) water, (e) a basic catalyst, (f) metal-oxide nanoparticles, and optionally, (g) a silane having at least one alkenyl group per molecule;
II) reacting the alkoxysilane (a) and the organosiloxane (b), in the presence of the acidic catalyst (c), the water (d), and optionally, the metal-oxide nanoparticles (f), to form an intermediate composition including monomers having hydroxyl groups;
III) reacting the monomers in the presence of the basic catalyst (e), and optionally, the metal-oxide nanoparticles (f), to form a silsesquioxane resin having residual hydroxyl groups; and
IV) optionally, reacting the silsesquioxane resin with the silane (g) to form the siloxane-modified metal-oxide nanoparticles having residual alkenyl groups;
wherein the metal-oxide nanoparticles (f) are present during at least one of steps II) and III).

2. The method as set forth in claim 1, wherein the metal-oxide nanoparticles:
i) are ZrO₂ nanoparticles or TiO₂ nanoparticles;
ii) have a mean particle diameter (D50) of from 1 to 100 nm; or
iii) both i) and ii).

3. (canceled)

4. The method as set forth in claim 1, wherein the alkoxysilane is MePhSi(OMe)₃ or PhSi(OMe)₃, where Ph is a phenyl group and Me is a methyl group.

5. The method as set forth in claim 1, wherein the organosiloxane is (ViMe₂Si)₂O, where Vi is a vinyl group and Me is a methyl group.

6. The method as set forth in claim 1, wherein the silane is ViMe₂SiCl, where Vi is a vinyl group and Me is a methyl group.

7. The method as set forth in claim 1, further comprising the step of removing water from the intermediate composition after step II) for inducing step III).

8. The method as set forth in claim 1, wherein the intermediate composition includes methanol, and further comprising the step of removing at least a portion of the methanol from the intermediate composition prior to step III).

9. The method as set forth in claim 1, further comprising the step of applying heat for a period of time during at least one of steps II) and III).

10. The method as set forth in claim 1, wherein at least one of steps II) and III) is conducted in the presence of a solvent different than the water (d).

11. The method as set forth in claim 1, wherein the siloxane-modified metal-oxide nanoparticles include a silsesquioxane resin of the general formula:
^{Vi}Mₐ^{PhMe}D_{b}^{Ph}T_{c}
where M is SiO_{1/2}, D is SiO_{2/2}, T is SiO_{3/2}, a is from 0.005 to 0.20, b is from 0.0 to 0.40, c is from 0.40 to 0.90, a+b+c=1, Vi is a vinyl group, Ph is a phenyl group, and Me is a methyl group.

12-13. (canceled)

14. A method of forming siloxane-modified metal-oxide nanoparticles, said method comprising the steps of:
I) providing (a) an acidic catalyst, (b) metal-oxide nanoparticles, (c) water, (d) an alcohol, (e) a solvent different than the water (c) and alcohol (d), and (f) an alkoxysilane having at least one acryl group per molecule;
II) combining the acidic catalyst (a), the metal-oxide nanoparticles (b), and the water (c) to form a first precursor composition;
III) combining the alcohol (d), the solvent (e), and the alkoxysilane (f) to form a second precursor composition; and
IV) reacting the first and second precursor compositions to form the siloxane-modified metal-oxide nanoparticles.

15. The method as set forth in claim 14, wherein the metal-oxide nanoparticles:
i) are ZrO₂ nanoparticles or TiO₂ nanoparticles;
ii) have a mean particle diameter (D50) of from 1 to 100 nm; or
iii) both i) and ii).

16. (canceled)

17. The method as set forth in claim 14, wherein the alkoxysilane is acryloxypropyltrimethoxysilane or methacryloxypropyltrimethoxysilane.

18. The method as set forth in claim 14, wherein the alcohol is methanol and the solvent is toluene.

19-20. (canceled)

21. A method of forming siloxane-modified metal-oxide nanoparticles, said method comprising the steps of:
I) providing (a) a sol comprising i) metal-oxide nanoparticles, ii) an acidic component, and iii) water, (b) an alcohol, (c) an alkoxysilane, and (d) a basic catalyst;
II) removing at least a portion of the water iii) from the sol (a) to obtain a particle composition;
III) mixing the alcohol (b) and the particle composition to form a transitional composition; and
IV) reacting the alkoxysilane (c) and the transitional composition to form monomers having hydroxyl groups; and
V) reacting the monomers in the presence of the basic catalyst (d) to form the siloxane-modified metal-oxide nanoparticles.

22. The method as set forth in claim 21, wherein the metal-oxide nanoparticles:
i) are ZrO₂ nanoparticles or TiO₂ nanoparticles;
ii) have a mean particle diameter (D50) of from 1 to 100 nm; or
iii) both i) and ii).

23. (canceled)

24. The method as set forth in claim 21, wherein the alkoxysilane is MePhSi(OMe)₃ or PhSi(OMe)₃, where Ph is a phenyl group and Me is a methyl group.

25. The method as set forth in claim 21, wherein after step I), the precursor composition consists essentially of the metal-oxide nanoparticles and the acidic component.

26-27. (canceled)

28. A method of forming siloxane-modified metal-oxide nanoparticles, said method comprising the steps of:
I) providing (a) linear- and/or cyclic-siloxane oligomers having residual hydroxyl groups, (b) metal-oxide nanoparticles, and (c) a basic catalyst; and
II) reacting the oligomers (a) in the presence of the metal-oxide nanoparticles (b) and the basic catalyst (c) to form the siloxane-modified metal-oxide nanoparticles.

29. The method as set forth in claim 28, wherein the metal-oxide nanoparticles:
i) are ZrO₂ nanoparticles or TiO₂ nanoparticles;
ii) have a mean particle diameter (D50) of from 1 to 100 nm; or
iii) both i) and ii).

30-32. (canceled)
